(19) United States
(12) Patent Application Publication
(10) Pub. No.: US 2019/0325523 A1
(43) Pub. Date: Oct. 24, 2019

(54) SYSTEMS AND METHODS OF GENERATING A POOLED INVESTMENT VEHICLE USING SHARED DATA

(71) Applicant: Wells Fargo Bank, N.A., San Francisco, CA (US)

(72) Inventors: Joshua T. Demetry, Menomonee Falls, WI (US); Daniel J. Johnson, Milwaukee, WI (US); Charles E. Paul, Cedarburg, WI (US); Kevin Roskopf, Brookfield, WI (US); Carolyn A. Wilary, Pewaukee, WI (US)

(21) Appl. No.: 15/957,176

(22) Filed: Apr. 19, 2018

(51) Int. Cl. G06Q 40/06; G06F 17/30

(52) U.S. Cl. CPC G06Q 40/06; G06F 17/30377

(57) ABSTRACT

A provider computing system includes a processing circuit, a network interface structured to facilitate data communication via a network, and a database structured to store information associated with transactions and accounts held by an institution associated with the provider computing system. The processing circuit is structured to collect user data relating to a group of users, wherein the collected user data relates to a pooled investment vehicle having a number of investment products for generating income. The processing circuit is further structured to transform the collected data to a data format corresponding to a statistical analysis model, determine whether a critical mass threshold value is exceeded, apply the statistical analysis model to the transformed data for determining a recommended investment decision in response to determining that the critical mass threshold value is exceeded, and generate a user interface configured to provide information relating to the recommended investment decision.

### BACKGROUND

A pooled investment vehicle allows individual consumers with varying amounts of capital to invest assets in one or more investment products. For example, a pooled investment vehicle may be a mutual fund that invests in a variety of stocks, bonds, market-related index funds, and other investment opportunities. By aggregating capital of each investor, the pooled investment vehicle may provide the investors with benefits that would otherwise be unavailable. For example, leveraging the aggregation of the investors' capital may provide increased negotiating power, which, in turn may allow a fund manager to negotiate lower trading costs. Furthermore, access to investment products requiring minimum investments may provide investors with increased choice, facilitate diversification, etc.

Investment decisions of a pooled investment vehicle are generally overseen by one or more fund managers. For example, the fund manager may control buying and selling decisions, and in return, collect a fee from the investors. The fund manager generally determines investment decisions based on market research and other data unrelated to the personal activities of the investors.

### SUMMARY

In one embodiment, a provider computing system is disclosed. The provider computing system includes a network interface, a database, and a processing circuit having a processor and a memory. The network interface is structured to facilitate data communication via a network. The database is structured to store information associated with transactions and information associated with accounts held by an institution associated with the provider computing system. The processor is structured to collect user data relating to a group of users, each of the users associated with a user device, wherein the collected user data relates to a pooled investment vehicle having a number of investment products for generating income. The processor is further structured to transform the collected data to a data format corresponding to a statistical analysis model. The processor is further structured to determine whether a critical mass threshold value is exceeded, the critical mass threshold value relating to an amount of collected user data. The processor is further structured to apply the statistical analysis model to the transformed data for determining a recommended investment decision for the pooled investment vehicle in response to determining that the critical mass threshold value is exceeded. The processor is further structured to generate a user interface for display by at least one of the user devices, the user interface configured to provide information relating to the recommended investment decision.

In another embodiment, a method is disclosed. The method includes collecting user data relating to a group of users, each of the users associated with a user device, wherein the collected user data relates to a pooled investment vehicle having a number of investment products for generating income. The method also includes transforming, by the provider computing system, the collected data to a data format corresponding to a statistical analysis model. The method also includes determining, by the provider computing system, a critical mass threshold value is exceeded, the critical mass threshold value relating to an amount of collected user data. The method also includes applying the statistical analysis model to the transformed data for determining a recommended investment decision for the pooled investment vehicle in response to determining that the critical mass threshold value is exceeded. The method also includes generating, by the provider computing system, a user interface for display by at least one of the user devices, the user interface configured to provide information relating to the recommended investment decision.

In another embodiment, a user device is disclosed. The user device includes a network interface and a processing circuit having a processor and a memory. The network interface is structured to facilitate data communication via a network. The processor is structured to collect user data corresponding to a user of the user device, the collected user data relating to a pooled investment vehicle having a number of investment products for generating income. The processor is further structured to determine whether a critical mass threshold value is exceeded, the critical mass threshold value relating to an amount of total user data, the total user data including the collected user data. The processor is further structured to transform the total user data to a data format corresponding to a statistical analysis model. The processor is further structured to apply the statistical analysis model to the transformed data for determining a recommended investment decision for the pooled investment vehicle in response to determining that the critical mass threshold value is exceeded. The processor is further structured to generate a user interface for display by the user device, the user interface configured to provide information relating to the recommended investment decision.

These and other features, together with the organization and manner of operation thereof, will become apparent from the following detailed description when taken in conjunction with the accompanying drawings.

### BRIEF DESCRIPTION OF THE FIGURES

The details of one or more implementations are set forth in the accompanying drawings and the description below. Other features, aspects, and advantages of the disclosure will become apparent from the description, the drawings, and the claims.

FIG. 1 is a block diagram of a system structured to facilitate generating and managing a pooled investment vehicle using shared data from investor(s) in the pooled investment vehicle, according to an example embodiment.

FIG. 2 is a diagram showing the analytics system of FIG. 1, according to an example embodiment.

FIG. 3 is a flow diagram of a method of generating and managing a pooled investment vehicle using shared data, according to an example embodiment.

FIG. 4 is another flow diagram of a method of generating and managing a pooled investment vehicle using shared data, according to an example embodiment.

### DETAILED DESCRIPTION

Before turning to the figures which illustrate example embodiments, it should be understood that the application is not limited to the details or methodology set forth in the following description or illustrated in the figures. It should also be understood that the phraseology and terminology employed herein is for the purpose of description only and should not be regarded as limiting. For example, the embodiments of systems and methods discussed herein may be relevant to any of a variety of circumstances where hedging against an inflation risk may be useful.

Referring to the figures generally, systems, methods, and apparatuses for generating and/or controlling the actions of a pooled investment vehicle using shared data are described herein. A provider computing system is structured to collect user data from any number and type of data sources, including user devices associated with investors. User data may be acquired “passively” or “actively.” For example, user data may be automatically provided by a user device associated with the user (i.e., passively or without user input), or be affirmatively or manually provided by a user using the user device (i.e., actively). In some embodiments, collected user data includes a combination of passively and actively provided data. The provider computing system is structured to determine behavioral characteristics based on the collected data. In some embodiments, the provider computing system is structured to transform or format the collected data to enable application of a statistical analysis model. The statistical analysis model can be configured to map certain behavioral characteristics to one or more investment products by application of a statistical model. The provider computing system can be structured to generate a recommended investment trade and/or automatically execute the trade. A recommended investment decision can relate to a recommendation for buying or selling a particular investment product for the pooled investment vehicle. The investment product may relate to a particular business entity (e.g., a publically traded stock associated with a restaurant) and/or a generic category associated with the particular business entity (e.g., a mutual fund that invests in restaurants or entertainment).

An example implementation may be described as follows. A group of users may desire to invest and participate in a pooled investment vehicle. The pooled investment vehicle includes various investment products (e.g., a stock, a mutual fund) and is configured to allocate assets to the investment products based on behavioral characteristics of the users. Behavioral characteristics may relate to patterns or trends of the users. For example, behavioral characteristics may relate to spending patterns with respect to a particular business entity (e.g., a specific restaurant) or a generic category of business entities (e.g., all restaurants of a genre, all restaurants, all entertainment). Behavioral characteristics can be determined based on data collected from any number of data sources, such as user devices associated with the users. For example, a user may indicate a desire to share data passively as collected by their associated user device, such as spending information and location information. The user may also actively provide information, such as confirmation of a particular transaction or an opinion of a good or service tendered to the user. A processing circuit collects and aggregates received information to map behavioral characteristics to investment products. Collected data is transformed or formatted to facilitate a statistical analysis model for investment product determinations. One or more financial trades may be automatically executed in response to the statistical analysis.

The embodiments and implementations of the systems and methods disclosed herein improve current systems by collecting and applying investor data to generate a higher-performing investment product and increase investment returns. In current systems, a fund manager generally oversees investment decisions of an investment vehicle. Investment decisions executed by the fund manager may lag behind market data, thereby diminishing potential investment returns. Moreover, available market data may be limited in application, restricting usability across the spectrum of potential investment products. Systems and methods disclosed herein incentivize users (investors) to provide and aggregate a robust collection of user data, which enables deeper insights regarding behavioral patterns and trends. Furthermore, user data can be collected in real-time or near real-time, facilitating rapid execution of financial trades and allowing increased investment returns.

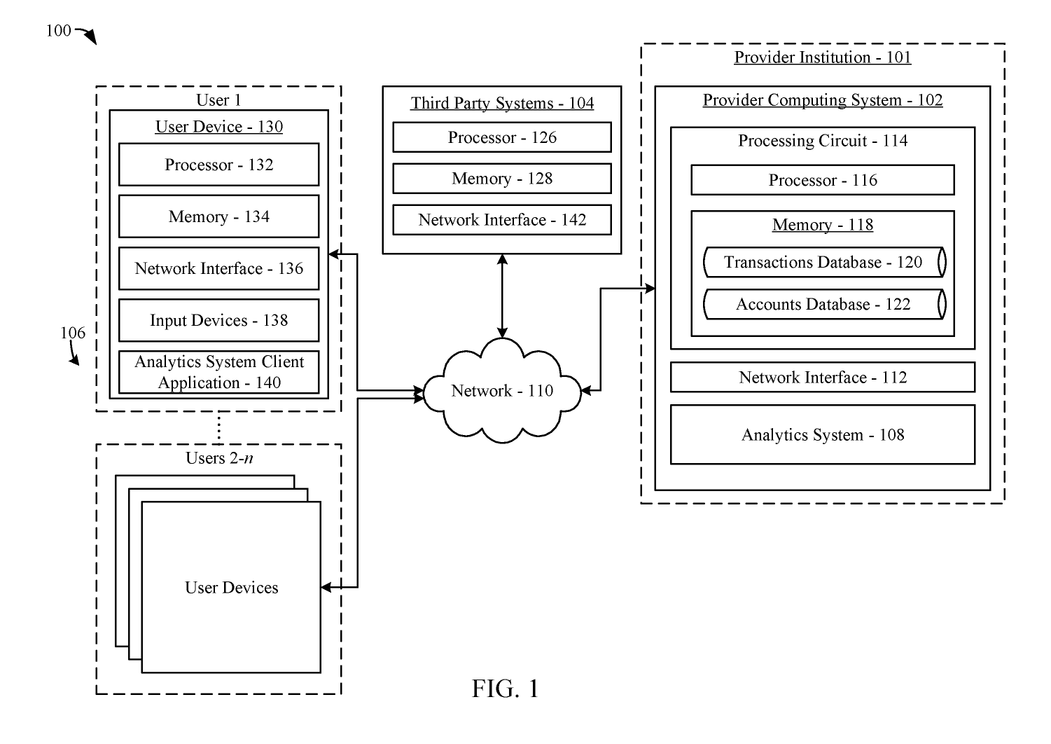

Referring now to FIG. 1, a block diagram of a system 100 is shown according to an example embodiment. As described in further detail herein, the system 100 is generally structured to facilitate generating and/or controlling the actions of a pooled investment vehicle using shared data. The system 100 is shown to include a provider computing system 102, third party systems 104, a set of user devices 106, and a network 110.

The network 110 generally provides communicable and operative coupling between the provider computing system 102, the third party systems 104, the set of user devices 106, and other components described herein to provide and facilitate the exchange of communications (e.g., data, instructions, messages, values, commands, etc.). Accordingly, the network 110 may include any network including wired (e.g., Ethernet) and/or wireless networks (e.g., 802.11X, ZigBee, Bluetooth, Wi-Fi, etc.). In some arrangements, the network 110 includes the Internet. In further embodiments, the network 110 includes a proprietary banking network to provide secure or substantially secure communications. The network 110 is structured to permit the exchange of data, values, instructions, messages, and the like between and among components of the system 100.

The provider computing system 102 is generally structured to communicate with external systems over the network 110 and is associated with the provider institution 101. The provider institution 101 may be a bank, a clearing house, or other financial institution. In one embodiment, the provider computing system 102 is structured to generate and/or control the actions of a pooled investment vehicle using data received from one or more components of the system 100.

The provider computing system 102 is shown to include a processing circuit 114 having a processor 116 and a memory 118. The processor 116 may be implemented as a general-purpose processor, an application specific integrated circuit (ASIC), one or more field programmable gate arrays (FPGAs), a digital signal processor (DSP), a group of processing components (e.g., servers), or other suitable electronic processing components. The memory 118 (e.g., RAM, ROM, NVRAM, Flash Memory, hard disk storage, etc.) may store data and/or computer code for facilitating at least some of the various processes described herein. In this regard, the memory 118 may store programming logic that, when executed by the processor 116, control the operation of the provider computing system 102. Moreover, the memory 118 may be or include tangible, non-transient volatile memory or non-volatile memory. Accordingly, the memory 118 may include database components, object code components, script components, or any other type of information structure for supporting the various activities and information structures described herein.

The provider computing system 102 further includes a network interface 112, which is used to establish connections with other components of the system 100 by way of the network 110. In this regard, the network interface 112 is structured to include any combination of hardware (e.g., Ethernet controller, memory, etc.) and software necessary to facilitate data communications for the provider computing system 102 over the network 110. For example, the network interface 112 can include a cellular transceiver (e.g., CDMA, GSM, LTE, etc.), a wireless network transceiver (e.g., 802.11X, ZigBee, Bluetooth, etc.), or a combination thereof (e.g., both a cellular transceiver and a Bluetooth transceiver). In some arrangements, the network interface 112 includes the hardware and machine-readable media sufficient to support communication over multiple channels of data communication. Further, in some arrangements, the network interface 112 includes cryptography capabilities to establish a secure or relatively secure communication session with the provider computing system 102. In this regard, data may be encrypted and transmitted to prevent or substantially prevent the threat of hacking.

The memory 118 is shown to include a transactions database 120 and an accounts database 122. In some embodiments, the memory 118 is structured to additionally include one or more databases of the analytics system 108 as described herein. Although shown as being part of the memory 118, in some arrangements of the system 100, the transactions database 120 and/or the accounts database 122 are separate components of the provider computing system 102.

The transactions database 120 is structured to hold, store, categorize, and otherwise serve as a repository for information associated with transactions by persons (e.g., users) and/or business entities associated with the provider institution 101, which manages, runs, or is otherwise associated with the provider computing system 102. Stored transactions can relate to credit card transactions, debit card transactions, checking transactions, online transactions, etc. In some embodiments, the transactions database 120 is structured to store information related to each transaction, such as a legal name, day and time of a transaction, a location of the transaction, a business entity name, a merchant category code, promotional information, a dollar amount, etc.

The accounts database 122 is structured to hold, store, categorize, or otherwise serve as a repository for information associated with accounts held by persons (e.g., users) and/or business entities associated with the provider institution 101. In some embodiments, the accounts database 122 is structured to store financial accounts held by a financial institution associated with the provider computing system 102. For example, the accounts database 122 may store financial information relating to a savings account, a checking account, investment accounts, retirement accounts, credit card accounts, and the like. The accounts database 122 may also store information relating to an account holder (e.g., a user associated with the user device 130). In this regard, stored information may include a legal name, current and former addresses, a government identification number, date of birth, and any other information relating to the user.

The transactions database 120 and the accounts database 122 is structured to selectively provide access to stored information. In this regard, each of the transactions database 120 and the accounts database 122 is communicably and operatively coupled to the analytics system 108. In some embodiments, information stored by the transactions database 120 and/or the accounts database 122 is selectively retrieved from external devices and systems via the network interface 112. For example, in some embodiments, the analytics system 108 may be provided externally to the provider computing system 102. In this regard, the stored information may be received from the transactions database 120 and/or the accounts database 122 through the network 110.

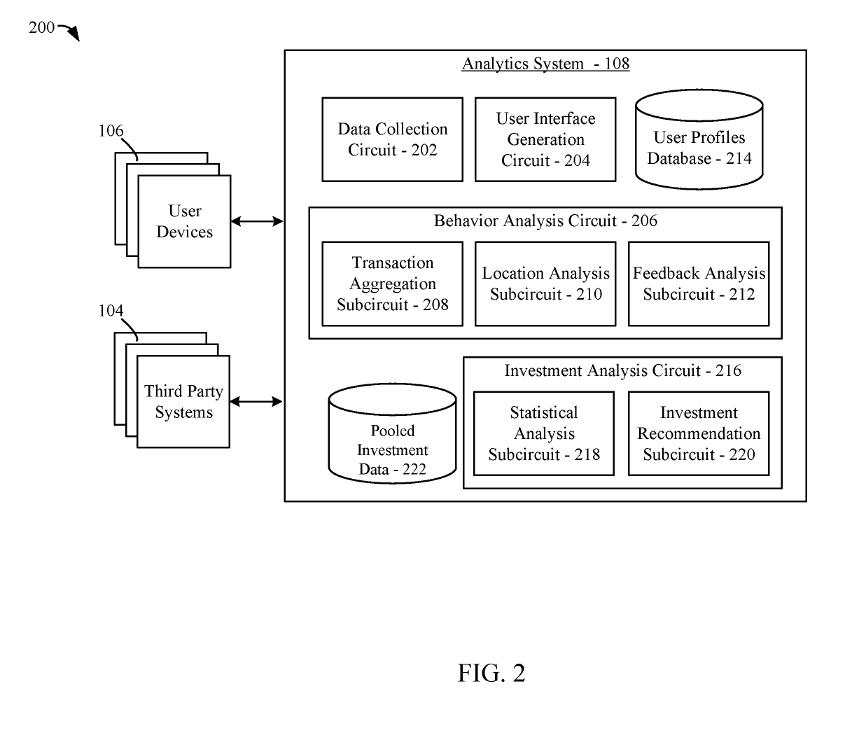

The analytics system 108 is generally structured to collect user-shared data and analyze the collected data for generating and managing a pooled investment vehicle as described herein. Collected data may be received from any component of the system 100, such as one or more user devices of the set 106. In some embodiments, the analytics system 108 is structured to automatically retrieve data according to a predetermined frequency. For example, the analytics system 108 can be structured to automatically collect location information of the user device 130 in hourly increments, and/or collect spending information from the transactions database 120 in daily increments. In some embodiments, analytics system 108 is structured to collect information based on a condition or event. Referring to the above example, when location information suggests a user visited a particular business, the analytics system 108 may prompt the user to provide confirmation of a purchase and/or provide a review of the business. In this regard, the analytics system 108 may also be structured to subsequently collect a user input from the user. The analytics system 108, including various structural and functional details, is described in further detail with reference to FIG. 2.

The system 100 is shown to include a set of user devices 106, which includes a user device 130 associated with a user. As used herein, a “user” is a person or entity participating in pooled investment vehicle. In some embodiments, at least one user is a customer of an institution associated with the provider computing system 102. The set of user devices 106 may include any number of user devices, each associated with a user. In some embodiments, more than one user device of the set 106 is associated with a particular user. It shall be appreciated that each of the user devices of the set 106 may be structured as described herein with reference to the user device 130.

As described herein, the user device 130 may be any type of device including, but not limited to, a phone (e.g., a smartphone), a tablet computer, a laptop computer, a personal digital assistant, and/or a wearable device. In some embodiments, the user device 130 is structured to communicate with components of the system 100 over the network 110, such as through a text or SMS message, an email, and/or an alert. In some embodiments, the user device 130 is structured to facilitate mobile payments, such as through an NFC transceiver and a mobile payment application.

The user device 130 is shown to include a processor 132, a memory 134, a network interface 136, input devices 138, and an analytics system client application 140. The processor 132 may be implemented as a general-purpose processor, an application specific integrated circuit (ASIC), one or more field programmable gate arrays (FPGAs), a digital signal processor (DSP), a group of processing components, or other suitable electronic processing components. The memory 134 (e.g., RAM, NVRAM, ROM, Flash Memory, hard disk storage, etc.) may store data and/or computer code for facilitating at least some of the various processes described herein. The memory 134 may be or include tangible, non-transient/non-transitory computer readable medium, volatile memory or non-volatile memory. Accordingly, the memory 134 may include database components, object code components, script components, or any other type of information structure for supporting at least some of the various activities and information structures described herein.

The network interface 136 is adapted for and structured to establish a communication session via the network 110 with various devices and/or systems, such as the provider computing system 102. Accordingly, the network interface 136 includes any of a cellular transceiver (e.g., CDMA, GSM, LTE, etc.), a wireless network transceiver (e.g., 802.11X, ZigBee, Bluetooth, etc.), or a combination thereof (e.g., both a cellular transceiver and a Bluetooth transceiver). Further, the network interface 136 may include cryptography capabilities to establish a secure or relatively secure communication session with the provider computing system 102. In this regard, data may be encrypted to prevent or substantially prevent the threat of hacking.

The analytics system client application 140 can be any suitable interface allowing a user to input, view, and/or otherwise exchange information between the user and one or more components of the user device 130. For example, the analytics system client application 140 may be configured to provide one or more questions and receive a user input regarding an opinion of a good or service tendered to the user. The analytics system client application 140 may be server-based applications executable on the user device 130. In this regard, a user may have to first download the application(s) prior to their usage. In another embodiment, the analytics system client application 140 may be hard coded into the memory of the user device 130. In an alternative embodiment, the analytics system client application 140 is a web-based interface application. In this configuration, the user may have to log onto or access the web-based interface before usage of the application(s). The analytics system client application 140 may be at least partly supported by a separate computing system comprising one or more servers, processors, network interface modules, etc. that transmit the applications for use to the user device 130. In yet another alternative embodiment, the analytics system client application 140 may include its own set of dedicated hardware components or substantially dedicated hardware components and associated logic. To facilitate integration, analytics system client application 140 may include an application programming interface (API) and/or a software development kit (SDK). All such variations and combinations are intended to fall within the spirit and scope of the present disclosure.

The input devices 138 includes one or more device configured to information associated with the user device 130 and/or the user. For example, in one embodiment, the input devices 138 includes a location tracking device as described herein. Any type and number of input devices 138 may be provided in various embodiments, which may include a keyboard, a touchscreen, a microphone, a mouse, switches, dials, buttons, and the like. In some embodiments, the input devices 138 include a camera or image-sensing device, which may be configured to receive biometric information relating to the user, such as a fingerprint, iris-based information, and facial recognition information. In some embodiments, the input devices 138 include a microphone configured to receive voice-based biometric identification information. The input devices 138 may include any combination of hardware components, communication circuitry, and machine-readable media for facilitating the exchange of data, values, messages, and the like between components of the user device 130 and/or the components of the system 100.

In some embodiments, at least one of the input devices 138 is structured to receive information relating to a position or movements of a user. For example, the input devices 138 may include a GPS device, an accelerometer, a gyroscope or gyro sensor, etc. In some embodiments, at least one of the input devices 138 is structured to receive information relating to environmental conditions, such as a temperature sensor, a barometer sensor, etc. In some embodiments, at least one of the input devices 138 is structured to receive health related information and measurements, such as a heart rate, a blood pressure, a blood-sugar level, an oxygen level, etc.

In some embodiments, the user device 130 is structured to “passively” (e.g., automatically) collect data via one of the input devices 138. Passively collected information can relate to a user input automatically received by the user device 130, such as via the input devices 138. In one example embodiment, passively collected data relates to location information automatically collected by the user device 130 as described herein. In this example, a geographical position or relative movements of the user device 130 (e.g., using GPS, triangulation) can suggest a geographical position or relative movements of the user associated with the user device 130. In another example, transaction information may be passively collected when the user device 130 is used to conduct a transaction with a merchant (e.g., via a mobile payments application). In this example, transaction information may include a dollar amount, a time, a date, a merchant name, a merchant category code, etc. Any type of data can be passively collected, which may depend on the type and configuration of the user device 130 and/or the input device 138. For example, health related information (e.g., blood pressure, heart rate, glucose level, etc.) may be passively collected when the user device 130 is a wearable device or when input devices 138 includes a device for collecting biometric information. Passively collected data is stored in the memory 134 and/or transmitted to a component of the system 100 as described herein.

In some embodiments, collected data may relate to information “actively” provided by a user. As used herein, actively provided information corresponds to information affirmatively provided by a user, such as a user input manually provided via the analytics system client application 140. The user input may relate to spending decisions, investment decisions, reviews of goods or services tendered to the user, problems or questions of a user, financial options, etc. In one example embodiment, actively provided information can include one or more questionnaire responses provided by the user via the analytics system client application 140. In some embodiments, actively provided information can be provided by the user as a text or SMS message. Actively provided data may generally be stored in the memory 134 and/or transmitted to a component of the system 100 (e.g., the provider computing system 102) as described herein.

The user device 130 may subsequently transmit collected data according to a defined event or condition. For example, the user device 130 can be structured to transmit stored data in response to a command or request received from the provider computing system 102 with an instruction to provide stored data. In some embodiments, the user device 130 may transmit stored data according to predetermined frequency (e.g., hourly, daily, weekly). In some embodiments, the user device 130 may transmit data in response to a user input, for example a request provided via the analytics system client application 140.

The system 100 is shown to include third party systems 104. The third party systems 104 may be a system associated with a business entity that operates or facilitates operation of a pooled investment vehicle. For example, the third party systems 104 may include a system capable executing decisions associated with assets of the pooled investment vehicle, such as buying and selling investment products. In some embodiments, the third party systems 104 includes a system that tracks economic data and/or market conditions, such as stock prices or market indices. In some embodiments, the third party systems 104 includes at least one system associated with a business entity (e.g., a credit card issuer and/or a merchant) that buys or sells products or services to a user. In this regard, the third party systems 104 is structured to communicate spending information, such as a credit card number, a legal name, an address, a merchant category code, and the like via the network interface 142. The third party systems 104 can include any type and number of systems.

The third party systems 104 is shown to include a processor 126, a memory 128, and a network interface 142. The processor 126 and the memory 128 is structured as described herein with reference to the processor 116 and the memory 118, respectively. The network interface 142 can be any suitable network interface, such as described herein with reference to the network interface 112. In this regard, the third party systems 104 is structured to send and receive data relating to transactions, instructions, and the like between the analytics system 108 via the network interface 142. In some embodiments, the third party systems 104 includes a database or repository. For example, the third party systems 104 can include a database structured to store financial information relating to transactions, merchants, historical and predicted market performance, economic growth, investment products, etc.

Referring to FIG. 2, the analytics system 108 is shown in further detail, according to an example embodiment. As described herein, the analytics system 108 is structured to generate and/or manage a pooled investment vehicle using data received from various components of the system 100, including at least one user device of the set 106. In this regard, the analytics system 108 is structured to send and receive data between at least one component of the system 100 via the network 110 or any other suitable wired or wireless networks. In one example implementation, the analytics system 108 is structured to receive location information of a user from the user device 130 via the network interface 112 of the provider computing system 102. In other implementations, whereby the analytics system 108 is provided as a separate component of the provider computing system 102, the analytics system 108 may be structured to receive location information via another network interface.

While the analytics system 108 is described as part of the provider computing system 102, one or more circuits of the analytics system 108 may be provided in the user device 130. Therefore, in other embodiments, the description of the operation of one or more circuits of the analytics system 108 may be applicable with the user device 130. In this regard, the user device 130 may be configured to perform some or all of the operations described herein with respect to analytics system 108 such as determining whether a critical mass threshold value is exceeded, the critical mass threshold value relating to an amount of total user data, the total user data including the collected user data; transforming the total user data to a data format corresponding to a statistical analysis model; in response to determining that the critical mass threshold value is exceeded, applying the statistical analysis model to the transformed data for determining a recommended investment decision for the pooled investment vehicle; and generating a user interface for display by the analytics system client application 140, the user interface configured to provide information relating to the recommended investment decision.

The analytics system 108 is shown to include a data collection circuit 202, a user interface generation circuit 204, a behavior analysis circuit 206, a user profiles database 214, an investment analysis circuit 216, and a pooled investment data database 222.

The data collection circuit 202 is structured to collect and aggregate data from at least one component of the system 100. In an example implementation, the data collection circuit 202 is structured to receive location information associated with the user device 130 to determine physical movement of a user as described herein. In another example implementation, the data collection circuit 202 is additionally or alternatively structured to receive spending information relating to the user from the user device 130 and/or the transactions database 120. In this regard, the received spending information may be used to determine spending patterns of the user, or indirectly determine geographic location and/or physical movement of a user.

In some embodiments, the data collection circuit 202 facilitates data collection by transmitting a command or request to a component of the system 100 with an instruction to provide user data. For example, the data collection circuit 202 may transmit one or more questions to the user device 130 for display to the user via the analytics system client application 140. In this regard, the data collection circuit 202 can provide an instruction to the user device 130 to receive user input provided by the user and transmit the user input to the data collection circuit 202. In some embodiments, the data collection circuit 202 is structured to continuously receive user data from a component of the system 100 (e.g., the user device 130) according to a predetermined frequency (e.g., every five minutes, every hour, etc.). In some embodiments, the data collection circuit 202 is structured to transmit a command or request with an instruction to provide received or stored data in response to a defined condition or event as described herein.

In some embodiments, data collected by the data collection circuit 202 may be classified as either “actively” provided information or “passively” provided information. As used herein, actively provided information corresponds to information affirmatively provided by a user, such as a user input manually provided via the analytics system client application 140. The user input may relate to spending decisions, investment decisions, reviews of goods or services tendered to the user, problems or questions of a user, financial options, etc. In one example embodiment, actively provided information can include one or more questionnaire responses provided by the user via the analytics system client application 140. In some embodiments, actively provided information can be provided by the user as a text or SMS message. Actively provided data may be received by the provider computing system 102 via the network interface 112. The provider computing system 102 can be structured to subsequently route the user input to the data collection circuit 202.

In some embodiments, the data collection circuit 202 is structured to collect “passively” provided information. As used herein, passively provided information can relate to a user input automatically received by a user device, such as the input devices 138 of the user device 130. Passively provided data can relate to location information automatically collected by the user device 130. For example, a geographical position or relative movements of the user device 130 (e.g., using GPS, triangulation) can suggest a geographical position or relative movements of the user associated with the user device 130. In another example, transaction information may be automatically collected when the user device 130 is used to conduct a transaction with a merchant (e.g., via a mobile payments application). In this example, transaction information may include a dollar amount, a time, a date, a merchant name, a merchant category code, etc. Any type of data can be automatically collected and passively provided to the data collection circuit 202. The type of passively provided information may depend on the type and configuration of the user device 130 and/or the input device 138. For example, health related information (e.g., blood pressure, heart rate, glucose level, etc.) may be automatically collected when the user device 130 is a wearable device or when input devices 138 includes a device for collecting biometric information.

In some embodiments, the data collection circuit 202 is structured to collect a combination of passively provided information and actively provided information. In one example implementation, the data collection circuit 202 may automatically collect location information of the user device 130 in response to receiving authorization from a user of the user device 130. In this example, the user may provide authorization via the analytics system client application 140 as actively provided information, and location information may be subsequently collected via the input devices 138 as passively provided information. Embodiments may use any combination of actively and passively provided information. Referring to the above example, the data collection circuit 202 can be structured to prompt the user to provide a user review (e.g., a score between one and five) of a particular business establishment when location information indicates the user visited the business establishment. The user review may be actively provided via the analytics system client application 140 and subsequently received by the data collection circuit 202.

In some embodiments, the data collection circuit 202 is structured to collect data from the third party systems 104, such as information relating to market conditions and other information that may be useful for generating and managing a pooled investment vehicle. In some embodiments, the data collection circuit 202 is structured to collect data stored in the memory 118 of the provider computing system 102. For example, the data collection circuit 202 can be structured to collect spending information stored in the transactions database 120 and/or account information stored in the accounts database 122. Collected data can generally relate to any type of information useful to facilitate systems and methods for generating and managing a pooled investment vehicle using shared data as described herein.

The data collection circuit 202 is structured to provide collected data to one or more components of the provider computing system 102 for generating and managing a pooled investment vehicle as described herein. In some embodiments, the data collection circuit 202 is structured to store collected data in one or more databases of the memory 118, such as the user profiles database 214, for example by associating collected data to one or more stored user profiles. The data collection circuit 202 can be additionally or alternatively structured to provide collected data to the behavior analysis circuit 206, the investment analysis circuit 216, and/or the user interface generation circuit 204.

The user profiles database 214 is structured to hold, store, categorize, and otherwise serve as a repository for information associated with each user of the pooled investment vehicle. In this regard, information associated with a particular user is stored in a corresponding user profile. Each user profile can include information relating to spending decisions, investments (e.g., a pooled investment vehicle the user participates in), reviews of goods or services tendered to the user, location information, personal characteristics, and other data relating to the user and/or a user device associated with the user as described herein.

A user profile stored in the user profiles database 214 can include nonfinancial information relating to the user. For example, a user profile can include identity-related or legal information of the user, such as a birthdate, a mailing address, marriage status, authentication information (e.g., login credentials, biometric information), etc. In some embodiments, a user profile can also include information relating to hobbies, interests, health information, medical conditions, and/or dependents.

In some embodiments, a stored user profile can also include location information of a user. For example, the location information may relate to a GPS position of a user device associated with the user. In this regard, the location information may include an indication of an amount of time in which the user device was at a particular location. In some embodiments, the location information relates to a time series of location position values according to a repeating time period, such as one minute increments, five minute increments, etc. In some embodiments, the repeating time period may vary based on a day of the week or time of the day. For example, a repeating time period of five minutes may be used for daytime hours and/or weekdays, and a repeating time period of thirty minutes may be used for nighttime hours and/or weekends.

A stored user profile can include financial information relating to the user, such as an investment portfolio, financial accounts, spending information, etc. An investment portfolio can include information relating to savings, assets, and investment products currently held by the user. For example, an investment portfolio can include any information relating to a checking account balance, a savings account balance, bonds, cash, annuities, and other investment products described herein. In some embodiments, a user profile can include spending information corresponding to the user as described herein. For example, spending information can relate to current and/or historical spending, such as specific transactions, a timeseries of transactions, patterns, and/or trends of spending. In this regard, spending information is organized according to a repeating time increment (e.g., amount of spend each month, each year).

The user interface generation circuit 204 is structured to generate a user interface for display by the analytics system client application 140. The generated user interface may include text, pictures, diagrams, input fields for user input, etc. In some embodiments, the user interface generation circuit 204 is structured to facilitate collecting actively provided information from the user. For example, the user interface generation circuit 204 can be structured to generate a user interface prompting a user to provide a user input, which may relate to confirmation of a particular transaction or an opinion of a good or service tendered by a merchant. In this regard, the generated user interface may include one or more input fields for a user to provide the user input. In some embodiments, the user interface generation circuit 204 is structured to generate a user interface with information relating to investment products, transactions, and stored user profiles.

The behavior analysis circuit 206 is structured to process user profile information, for example by categorizing and/or filtering data of each user profile, to determine behavioral characteristics. In one example implementation, user profile information can be categorized to identify a number of visits to a particular location, an amount of spend of each visit, positive or negative reviews, and the like. In this regard, one or more circuits of the analytics system 108 (e.g., the statistical analysis subcircuit 218) can analyze the behavioral characteristics to identify trends, patterns, and the like for generating a recommended investment as described herein. In some embodiments, the behavior analysis circuit 206 is structured to receive user profile information from the user profiles database 214 and/or other components of the system 100. In some embodiments, the behavior analysis circuit 206 is structured to store behavior characteristic information in the pooled investment data database 222.

In some embodiments, determined behavioral characteristics may be based on all stored user profiles. However, in other embodiments, determined behavioral characteristics may be based on a subset of user profiles. In some embodiments, determined behavioral characteristics may be based on a subset of information of each user profile as described herein. In an example embodiment, the behavior analysis circuit 206 may analyze user profile information to determine behavioral characteristics relating to visits of a geographical location by users who are within a particular age group, who spent a certain threshold of money at business associated with the geographical location, who invest a certain amount of money in a pooled investment vehicle, and who have a particular income level.

Determined behavioral characteristics are stored in the pooled investment data database 222 and may be subsequently retrieved by the investment analysis circuit 216 for statistical analysis as described herein. Any combination of behavioral characteristics may be selectively used in various embodiments. For example, behavioral characteristics that are relevant or likely relevant to a particular statistical model may be selectively used and stored in the pooled investment data database 222. Accordingly, data stored in the pooled investment data database 222 may represent a “filtered” set of data of the user profiles database 214. In this regard, efficiency and computing speed of the analytics system 108 may be increased, and in turn allow quicker execution of trades.

The behavior analysis circuit 206 may be structured to include various subcircuits to facilitate determining behavioral characteristics. For example, the behavior analysis circuit 206 is shown to include a transaction aggregation subcircuit 208, a location analysis subcircuit 210, and a feedback analysis subcircuit 212. In some embodiments, one or more of the transaction aggregation subcircuit 208, the location analysis subcircuit 210, and the feedback analysis subcircuit 212 is not provided or is provided separately from the behavior analysis circuit 206.

The transaction aggregation subcircuit 208 is structured to receive and classify spending information as a behavioral characteristic. Spending information may include information relating to transactions between a user and a merchant, such as a merchant name, a time, a date, a dollar amount of a transaction, a merchant category code, a particular promotion, etc. In this regard, spending information may be received from the user profiles database 214, one or more user devices of the set 106, third party systems 104, the transactions database 120, the accounts database 122, and any other component of the system 100 as described herein.

In some embodiments, the transaction aggregation subcircuit 208 is structured to classify or categorize received spending information according to a particular business entity or a generic category. For example, the transaction aggregation subcircuit 208 can be structured to categorize all users' transactions at a particular restaurant. In another example, the transaction aggregation subcircuit 208 is structured to categorize all users' transactions at all restaurants. Similarly, the transaction aggregation subcircuit 208 can categorize all users' transactions associated with entertainment spending, which may include all restaurants and as well as other forms of entertainment. In this regard, the transaction aggregation subcircuit 208 can be structured to further classify transactions based on additional characteristics. Referring to the above example, the transaction aggregation subcircuit 208 can be structured to further categorize the users' transactions at the particular restaurant according to a particular time period (e.g., each week, each month, time of day, day of week).

The location analysis subcircuit 210 is structured to determine spending information and other behavioral characteristics based on location information. Location information may be received from any component of the system 100, including the user device 130. In some embodiments, location information relates to a geographic location of the user device 130 (e.g., using GPS, triangulation). In this regard, location information of the user device 130 may suggest a geographic location of the user and/or a particular address of the geographic location. For example, a distance value between a geographic location of the user device 130 and a particular merchant address is compared to a threshold value to determine whether the user likely visited the merchant. In some embodiments, the location analysis subcircuit 210 is structured to store location information of a user in a corresponding user profile stored in the user profiles database 214. In some embodiments, one or more features of the location analysis subcircuit 210 described herein may be performed by another component of the analytics system 108.

The location analysis subcircuit 210 is not limited to receiving only GPS information for determining geographic location information of a user. Rather, the location analysis subcircuit 210 can be structured to determine a geographic location of a user based on any type of data, received from any component of the system 100. In one example embodiment, the location analysis subcircuit 210 can be structured to determine an indication of a geographic location of a user based on spending information. Spending information may indicate or suggest that the user conducted a particular transaction with a merchant while being physically present at a brick and mortar location. In this regard, the location analysis subcircuit 210 is structured to receive transaction information stored in the transactions database 120. In another example embodiment, geographic location information may be based on an explicit input actively provided by a user. For example, a user may “check-in” to a business establishment or location via the user device 130 (e.g., a mobile application).

In some embodiments, the location analysis subcircuit 210 is structured to receive metadata or information relating to location information. For example, the location analysis subcircuit 210 can be structured to receive information regarding a time and date associated with a location of the user device 130 as described herein. The location analysis subcircuit 210 is structured to receive and use any type of information that may be useful for generating conclusions regarding behavioral characteristics of the user, including but not limited to weather, business information, historical user profile data, etc.

The location analysis subcircuit 210 is structured to generate various conclusions regarding behaviors of the user, including transactions and spending patterns, to identify behavioral characteristics. For example, the location analysis subcircuit 210 may determine that a user associated with the user device 130 likely played a round of golf when location information of the user device 130 suggests the user visited a golf course for a period of four hours during an afternoon. In contrast, the location analysis subcircuit 210 may determine that the user did not play a round of golf when location information of the user device 130 suggests the user visited a golf course for a period of ten minutes. The location analysis subcircuit 210 is structured to use any type of data from any source to facilitate generating conclusions. Referring to the above example, the location analysis subcircuit 210 can be structured to receive weather data to facilitate generating a conclusion regarding user activities.

The feedback analysis subcircuit 212 is structured to determine behavioral characteristics relating to a user experience or review of a tendered good or service. For example, when location information suggests that a user may have visited a particular business entity, the feedback analysis subcircuit 212 can generate one or more questions or prompts that may be useful for confirming the user visited the business entity. Referring to the above example, the feedback analysis subcircuit 212 may generate a series of questions confirming whether the user played a round of golf. Questions or prompts may be provided to the user using any suitable means. For example, one or more circuits of the provider computing system 102 is structured to transmit a SMS or text message to a user device associated with the user (e.g., the user device 130). In this regard, the data collection circuit 202 is structured to receive a responsive user input and route the user input to the feedback analysis subcircuit 212. In some embodiments, the user interface generation circuit 204 is structured to generate a user interface on the user device 130 to facilitate gathering the user input, as described herein.

The feedback analysis subcircuit 212 is structured to generate any type and number of questions or prompts in various embodiments. In some embodiments, feedback analysis subcircuit 212 may additionally or alternatively generate questions or prompts relating to a transaction, a merchant, and/or a third party. For example, a generated question may relate to an opinion of a good or service tendered to the user, such as review or a rating of a particular merchant. Another generated question may relate to a dollar amount of spend, whether the user would recommend the good or service to others, etc.

Still referring to FIG. 2, the analytics system 108 is shown to include an investment analysis circuit 216. The investment analysis circuit 216 is structured to facilitate generating and managing a pooled investment vehicle, for example by determining recommended investment trades and/or executing the trades as described herein. For example, a trade relate to adjusting a proportion of investment (e.g., shares, a dollar amount) of a particular investment product, which may be a stock, a mutual fund, an ETF, a CD (certificate of deposit), a banking product (e.g., a money market account, a savings account), a bond, an annuity, a retirement account, a college savings fund, an options, a commodity future, an insurance product, an alternative currency, etc. In some embodiments, the investment analysis circuit 216 is structured to exchange data between the third party systems 104 as described herein, for example to execute trades, receive economic or market data, etc.

The investment analysis circuit 216 may be structured to include various subcircuits to facilitate determining recommended changes to a pooled investment vehicle. For example, the investment analysis circuit 216 is shown to include a statistical analysis subcircuit 218 and an investment recommendation subcircuit 220. In some embodiments, one or more of the statistical analysis subcircuit 218 and the investment recommendation subcircuit 220 is not provided or is provided separately from the investment analysis circuit 216. In some embodiments, the investment analysis circuit 216 is structured to store information relating to each pooled investment vehicle in the pooled investment data database 222.

In some embodiments, the statistical analysis subcircuit 218 is structured to receive data relating to behavioral characteristics of users for statistical analysis to determine or map relationships between user behaviors and various investment products. For example, if behavioral characteristic data indicates an increased use of a particular retailer, the statistical analysis subcircuit 218 may apply a statistical analysis technique to predict how the increase applies to a broader population in terms of returns or losses of an investment product. As described herein, the investment recommendation subcircuit 220 is structured to map the statistical analysis output to one or more investment products (e.g., a stock associated with the retailer, a mutual fund that invests in a related industry). Furthermore, the statistical analysis subcircuit 218 can also be structured to identify indirect effects to various investment products. For example the statistical analysis subcircuit 218 may identify a correlation suggesting an increase in investment returns of a particular supplier or commodity trader.

The statistical analysis subcircuit 218 is structured to use any suitable statistical analysis technique to determine or map relationships between user behaviors and various investment products. In one example implementation, the statistical analysis subcircuit 218 is structured to calculate a score based on an algorithm, such as a weighted formula. The score may represent a sum of visits by some or all users to a particular business establishment (e.g., a specific restaurant) or a generic category of business establishments (e.g., all restaurants). The score can be calculated according to a particular time period (e.g., a day, a week, a month) to facilitate identifying trends or patterns over time. In some embodiments, the score can be calculated based on attaching various weights to each visit. For example, a particular visit by a user may be weighted higher when the user invests an amount of money above a threshold value in the pooled investment vehicle. In another example, a particular visit may be weighted higher when the user spends an amount of money above a threshold value during the visit. In another example, a particular visit may be weighted according to feedback received from the user, such that the visit is weighted higher in response to a positive review and weighted lower in response to a negative review.

In some embodiments, the statistical analysis subcircuit 218 is structured to perform an artificial intelligence or machine learning technique (e.g., Bayesian networks, link analysis, classification, linear regression, logistic regression, dimension reduction, clustering, principal component analysis, anomaly-detection). For example, regression analysis may be used to map data to categories or types of investment products. In another example, the statistical analysis subcircuit 218 may use a machine learning process to identify correlations between behavioral characteristics and investment products. In some embodiments, the statistical analysis subcircuit 218 may use a machine learning process to generate or update a data model.

In some embodiments, the statistical analysis subcircuit 218 is structured to transform or otherwise manipulate data (e.g., behavioral characteristic information) to facilitate statistical analysis. The type and format of data transformation generally depends on the particular statistical analysis used, and in this regard, any suitable data transformation may be used to facilitate the statistical analysis. For example, when the statistical analysis involves applying behavioral characteristics data to a linear regression model, the data may be transformed to improve linearity between independent and dependent variables, to stabilize variance, to reduce skewness (e.g., using a symmetric distribution), and the like. In some embodiments, the statistical analysis subcircuit 218 may standardize data. For example, referring to the weighted formula described above, one or more weights (e.g., an amount of spend at a business) may be standardized to a particular scale (e.g., a normal or bell-shaped distribution). Data may be further normalized, encoded, and the like.

In some embodiments, the statistical analysis subcircuit 218 is structured to determine whether a critical mass threshold value is exceeded. As used herein, a “critical mass threshold value” refers to a minimum value in which collected data becomes sufficiently statistically significant, for example for generating or executing a recommended investment decision. In this regard, once the critical mass threshold value is surpassed, a certain amount of control of the pooled investment vehicle may be affected by one or more decisions or actions of investors.

In one example embodiment, the critical mass threshold value refers to a defined number, such a number of users participating in the pooled investment vehicle. In this example, once the critical mass threshold value is exceeded, the statistical analysis subcircuit 218 may be configured to generate one or more recommended investment decisions for the pooled investment vehicle. In another example embodiment, the critical mass threshold value may refer to a minimum number of visits to a particular business establishment for identifying a trend or pattern. In another example embodiment, the critical mass threshold value may relate to a calculated score based on the weighted formula described above. In this regard, when the calculated score exceeds the critical mass threshold value, the statistical analysis subcircuit 218 may generate a recommended investment decision and/or automatically execute the recommended investment decision as described herein. The critical mass threshold value may be a whole number, percentage, or ratio relating to a number of users, behavioral characteristics of the users, the amount and type of user data collected, the type of investment product, the amount of investment, etc.

In some embodiments, the statistical analysis subcircuit 218 is structured to analyze multiple characteristics of collected user data and/or various relationships of the characteristics. For example, an investment amount may be commensurate with a critical mass threshold value, such that a larger investment may require a larger number of users. In some embodiments, the statistical analysis subcircuit 218 is structured to sequentially determine whether two or more critical mass threshold values are exceeded. For example, a first critical mass threshold value may require at least one hundred users and a second critical mass threshold value may require at least three hundred users. Upon meeting the first critical mass threshold value, one or more recommended investment decisions may be generated by the investment recommendation subcircuit 220. The recommended investment decisions may be automatically executed by the investment recommendation subcircuit 220 upon meeting the second critical mass threshold value.

In some embodiments, the investment recommendation subcircuit 220 is structured to generate one or more investment recommendations based on the statistical analysis. For example, the investment recommendation subcircuit 220 may recommend buying or selling a particular investment product. The investment product may relate to a particular business entity (e.g., a publically traded stock associated with a restaurant) and/or a generic category associated with the particular business entity (e.g., a mutual fund that invests in restaurants or entertainment) as described herein.

In some embodiments, the investment recommendation subcircuit 220 is structured to generate information for executing a trade of the particular investment product. For example, the investment analysis circuit 216 can be structured to interact with the user interface generation circuit 204 to generate a user interface displaying information related to a recommendation. In this regard, the generated user interface is configured to receive a user input relating to whether to execute the trade. For example, if a sufficient number of users provide a user input indicating to execute the trade, the investment analysis circuit 216 is structured to execute the trade. In some embodiments, the investment analysis circuit 216 is structured to automatically execute the recommendation, for example upon meeting a particular condition (e.g., consent of users, meeting a threshold value).

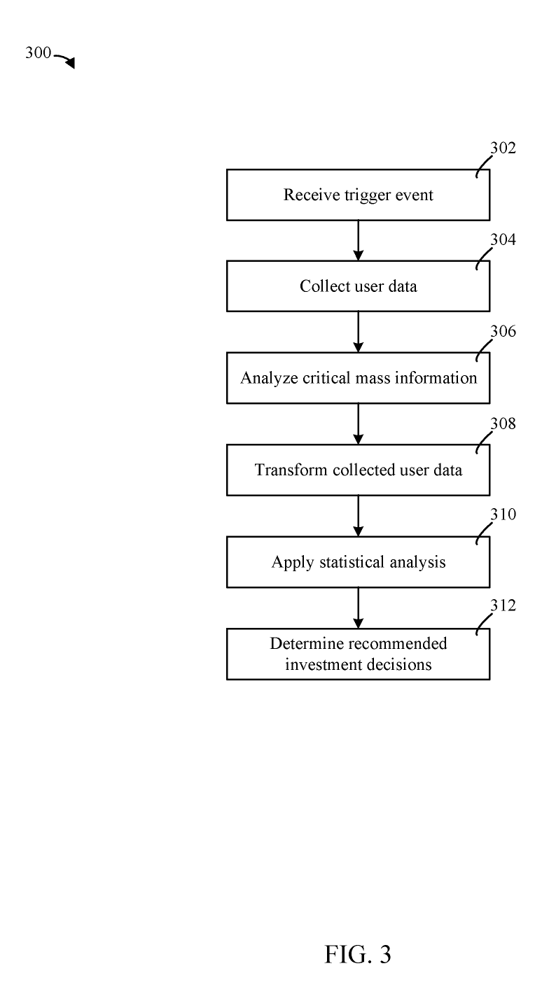

Referring to FIG. 3, a flow diagram of a method 300 for generating and managing a pooled investment vehicle using shared data is shown according to an example embodiment. In some embodiments, the method 300 is performed by one or more circuits of the provider computing system 102 (e.g., the analytics system 108). In some embodiments, one or more steps of method 300 are not provided.

At step 302, a trigger event is received. In some embodiments, a trigger event relates to a user request to participate in a pooled investment vehicle. For example, the trigger event can be provided via a user interface of a user device associated with the user. In some embodiments, the trigger event corresponds to an indication that the user desires to participate in the pooled investment vehicle. In some embodiments, the trigger event corresponds to an indication that the user desires to share user data as described herein (e.g., passively collected data). In some embodiments, the trigger event relates to a number of user requests to participate in the pooled investment vehicle.

At step 304, user data is collected. User data can be collected from any component of the system 100, such as one or more of the set of user devices 106, the third party systems 104, and/or the provider computing system 102. In some embodiments, collected user data is aggregated and associated with a stored user profile (e.g., in the user profiles database 214) corresponding to the user.

Collected data can generally relate to any type of information useful to facilitate systems and methods for generating and managing a pooled investment vehicle using shared data as described herein. For example, collected data can relate to particular transactions, location information, health information, etc. In some embodiments, collected data can also relate to a market conditions and other information that may be useful for generating and managing a pooled investment vehicle. In some embodiments, collected data can relate to spending, investment products, and other user profile information as described herein. For example, collected data can relate to spending information stored in the transactions database 120 and/or account information stored in the accounts database 122.

In some embodiments, data is collected in response to a request to provide user data. In some embodiments, data is continuously collected from at least one user device of the set of user devices 106 according to a predetermined frequency (e.g., every five minutes, every hour, etc.) as described herein. In some embodiments, data is collected in response to a particular condition or event as described herein.

In some embodiments, collected data relates to “actively” provided information as described herein. For example, actively provided information can correspond to a user input manually provided by a user via the analytics system client application 140 of the user device 130. The user input may relate to spending decisions, investment decisions, reviews of goods or services tendered to the user, problems or questions of a user, financial options, etc. In one example embodiment, actively provided information can include one or more questionnaire responses provided by the user via the analytics system client application 140. In some embodiments, actively provided information can be provided by the user as a text or SMS message. In this regard, the user input may have been selectively submitted or transmitted (e.g., from the user device 130) and subsequently collected by the provider computing system 102 via the network interface 112.

In some embodiments, collected data relates to “passively” provided information as described herein. Passively provided data can relate to location information automatically collected by the user device 130. For example, a geographical position or relative movements of the user device 130 (e.g., using GPS, triangulation) can suggest a geographical position or relative movements of the user associated with the user device 130. In another example, transaction information may be automatically collected when the user device 130 is used to conduct a transaction with a merchant (e.g., via a mobile payments application). In this example, transaction information may include a dollar amount, a time, a date, a merchant name, a merchant category code, etc. Any type of data can be passively provided and may depend on the type and configuration of the user device 130 and/or the input device 138. For example, health related information (e.g., blood pressure, heart rate, glucose level, etc.) may be passively provided when the user device 130 is a wearable device or when input devices 138 includes a device for collecting biometric information.

In some embodiments, collected data relates to a combination of passively provided information and actively provided information. In one example implementation, location information of the user device 130 may be passively provided in response to initially receiving authorization from a user of the user device 130. In this example, the user may provide authorization via the user device 130 as actively provided information. Embodiments may use any combination of actively and passively provided information. Referring to the above example, a user review of a particular business establishment may be actively provided when location information indicates the user visited the business establishment.

At step 306, critical mass threshold value is analyzed to determine whether it has been exceeded. As used herein, a “critical mass threshold value” refers to a minimum value in which collected data becomes sufficiently statistically significant, for example for generating or executing a recommended investment decision. In this regard, once the critical mass threshold value is surpassed, a certain amount of control of the pooled investment vehicle may be affected by one or more decisions or actions of investors. In some embodiments, step 306 is performed with step 308 and/or step 310, for example when a critical mass threshold value relates application of a statistical analysis model.

In one example embodiment, the critical mass threshold value refers to a defined number, such a number of users participating in the pooled investment vehicle. In this example, once the critical mass threshold value is exceeded, one or more recommended investment decisions for the pooled investment vehicle may be generated. In another example embodiment, the critical mass threshold value may refer to a minimum number of visits to a particular business establishment for identifying a trend or pattern. In another example embodiment, the critical mass threshold value may relate to a calculated score based on the weighted formula described with reference to FIG. 2. The critical mass threshold value may relate to a number of users, characteristics of the users, the amount and type of user data collected, the type of investment product, the amount of investment, etc.

At step 308, the collected data is transformed. In some embodiments, the collected data is transformed to a format corresponding to a particular statistical analysis model to facilitate application of the statistical analysis model. Accordingly, step 308 may be performed in conjunction with step 310. For example, when the statistical analysis involves applying behavioral characteristics data to a linear regression model, the data may be transformed to improve linearity between independent and dependent variables, to stabilize variance, to reduce skewness (e.g., using a symmetric distribution), and the like. In some embodiments, step 306 involves standardizing data. For example, referring to the weighted formula described with reference to FIG. 2, one or more weights (e.g., an amount of spend at a business) may be standardized to a particular scale (e.g., a normal or bell-shaped distribution). Data may be further normalized, encoded, and the like.

At step 310, a statistical analysis model is applied to transformed data to identify one or more recommended trades of the pooled investment vehicle, such buying or selling a particular investment product. In this regard, step 310 may involve a statistical analysis model to identify trends or patterns for generating and/or modifying investment products of a pooled investment vehicle. An investment product may relate to a particular business entity (e.g., a publically traded stock associated with a restaurant) and/or a generic category associated with the particular business entity (e.g., a mutual fund that invests in restaurants or entertainment) as described herein. Any suitable statistical analysis model can be used to determine or map relationships between user behaviors and various investment products, such as an artificial intelligence or machine learning technique (e.g., Bayesian networks, link analysis, classification, linear regression, logistic regression, dimension reduction, clustering, principal component analysis, anomaly-detection). For example, in some embodiments, regression analysis may be used to map data to investment products. In this regard, step 308 can involve initially manipulating or transforming collected user data to facilitate the regression analysis.

At step 312, at least one recommended investment decision is determined. A recommended investment decision can relate to a recommendation for buying or selling a particular investment product for the pooled investment vehicle. The investment product may relate to a particular business entity (e.g., a publically traded stock associated with a restaurant) and/or a generic category associated with the particular business entity (e.g., a mutual fund that invests in restaurants or entertainment) as described herein.

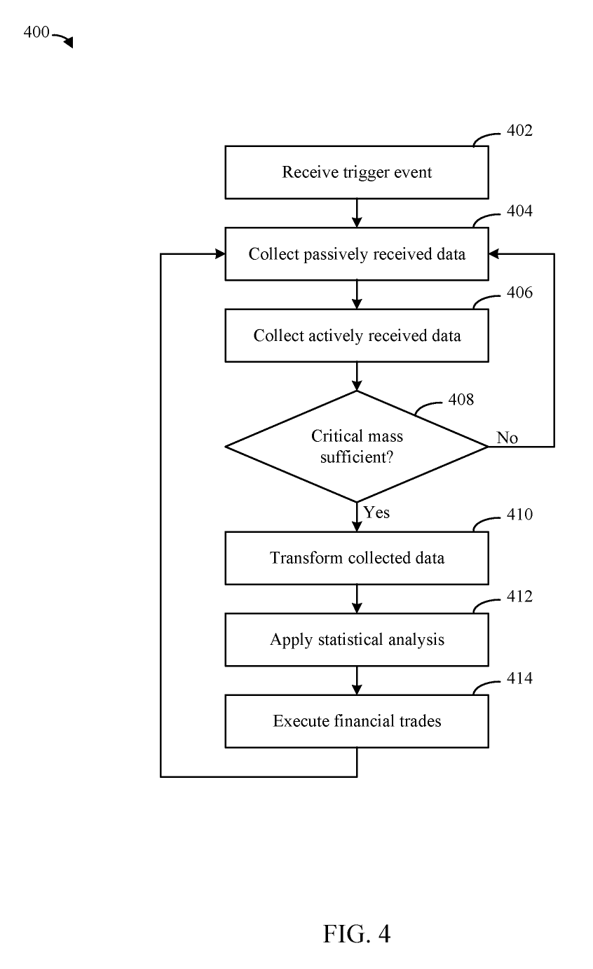

Referring to FIG. 4, another flow diagram of a method 400 for generating and managing a pooled investment vehicle using shared data is shown according to an example embodiment. In some embodiments, the method 400 describes how various portions of the method 300 can be automated, for example using various feedback loops and automatically executing financial trades. In some embodiments, method 400 can be performed after method 300 is performed (i.e., after a pooled investment vehicle has been generated). For example, method 400 may allow automatically adjusting financial positions of various investment products in response to real-time information. In some embodiments, the method 400 is performed by one or more systems or circuits of the provider computing system 102 (e.g., the analytics system 108). In some embodiments, one or more steps of method 400 are not provided.

At step 402, a trigger event is received. In some embodiments, a trigger event relates to a user request to participate in a pooled investment vehicle. For example, the trigger event can be provided via a user interface of a user device associated with the user. In some embodiments, the trigger event corresponds to an indication that the user desires to participate in the pooled investment vehicle. In some embodiments, the trigger event corresponds to an indication that the user desires to share user data as described herein (e.g., passively collected data). In some embodiments, the trigger event relates to a number of user requests to participate in the pooled investment vehicle.

At steps 404-406, user data is collected. For each of steps 404-406, user data can be collected from any component of the system 100, such as one or more of the set of user devices 106, the third party systems 104, and/or the provider computing system 102. In some embodiments, collected user data is aggregated and associated with a stored user profile (e.g., in the user profiles database 214) corresponding to the user.

For each of steps 404-406, collected data can generally relate to any type of information useful to facilitate systems and methods for generating and managing a pooled investment vehicle using shared data as described herein. For example, collected data can relate to particular transactions, location information, health information, etc. In some embodiments, collected data can also relate to a market conditions and other information that may be useful for generating and managing a pooled investment vehicle. In some embodiments, collected data can relate to spending information, investment products, and other user profile information as described herein. For example, collected data can relate to spending information stored in the transactions database 120 and/or account information stored in the accounts database 122. In some embodiments, data is collected in response to a request to provide user data. In some embodiments, data is continuously collected from at least one user device of the set of user devices 106 according to a predetermined frequency (e.g., every five minutes, every hour, etc.) as described herein. In some embodiments, data is collected in response to a particular condition or event as described herein.

At step 404, “passively” received data is collected. Passively collected data can relate to a user input automatically received (e.g., by the input devices 138 of the user device 130). For example, passively collected data can relate to geographic location information of the user device 130, such as a GPS position. In some embodiments, passively collected data can relate to health information of the user associated with the user device 130. In some embodiments, passively collected data can relate to transaction or spending information.

At step 406, “actively” provided data is collected. Actively provided data can correspond to a user input manually provided by a user via the analytics system client application 140 of the user device 130. The user input may relate to spending decisions, investment decisions, reviews of goods or services tendered to the user, problems or questions of a user, financial options, etc. In this regard, the user input may have been selectively submitted or transmitted (e.g., from the user device 130) and subsequently collected by the provider computing system 102 via the network interface 112.

In an example embodiment, step 404 may have involved collecting location information of a user device associated with a user, and accordingly, step 406 may involve receiving a confirmation that a user visited a particular merchant nearby a location associated with the collected location information. Additionally or alternatively, step 406 may involve receiving an opinion of a good or service tendered by the merchant.

At step 408, critical mass information is analyzed to determine whether a critical mass threshold value is exceeded. As used herein, a “critical mass threshold value” refers to a minimum value in which collected data becomes sufficiently statistically significant, for example for generating or executing a recommended investment decision. In this regard, once the critical mass threshold value is surpassed, a certain amount of control of the pooled investment vehicle may be affected by one or more decisions or actions of investors.

In one example embodiment, the critical mass threshold value refers to a defined number, such a number of users participating in the pooled investment vehicle. In this example, once the critical mass threshold value is exceeded, one or more recommended investment decisions for the pooled investment vehicle may be generated. In another example embodiment, the critical mass threshold value may refer to a minimum number of visits to a particular business establishment for identifying a trend or pattern. In another example embodiment, the critical mass threshold value may relate to a calculated score based on the weighted formula described with reference to FIG. 2. In this regard, step 410 and/or step 412 may be performed in conjunction or prior to step 408. The critical mass threshold value may relate to a number of users, characteristics of the users, the amount and type of user data collected, the type of investment product, the amount of investment, etc.

When the critical mass threshold value is exceeded, the process continues to step 410. When the critical mass threshold value is not exceeded, the process returns to step 404. In this regard, the method 400 is configured to continuously and automatically receive information until a sufficient type and amount of data is received (e.g., when the threshold value is exceeded). In some embodiments, the process continues directly to step 414 when steps 410-412 are performed in conjunction with step 408. For example, step 408 may involve determining whether a critical mass threshold value is exceeded based on application of a statistical analysis model.

At step 410, the collected data is transformed. In some embodiments, the collected data is transformed to a format corresponding to a particular statistical analysis model to facilitate application of the statistical analysis model, and thus step 410 may be performed in conjunction with step 412. For example, when the statistical analysis involves applying behavioral characteristics data to a linear regression model, the data may be transformed to improve linearity between independent and dependent variables, to stabilize variance, to reduce skewness (e.g., using a symmetric distribution), the like. In some embodiments, data may be standardized as described herein.

At step 412, a statistical analysis model is applied to transformed data to identify one or more recommended trades of the pooled investment vehicle, such buying or selling a particular investment product. In this regard, step 412 may involve a statistical analysis model to identify trends or patterns for generating and/or modifying investment products of a pooled investment vehicle. An investment product may relate to a particular business entity (e.g., a publically traded stock associated with a restaurant) and/or a generic category associated with the particular business entity (e.g., a mutual fund that invests in restaurants or entertainment) as described herein. Any suitable statistical analysis model can be used to determine or map relationships between user behaviors and various investment products, such as an artificial intelligence or machine learning technique (e.g., Bayesian networks, link analysis, classification, linear regression, logistic regression, dimension reduction, clustering, principal component analysis, anomaly-detection). For example, in some embodiments, a weighted formula may be used as described herein. In another embodiment, regression analysis may be used to map data to investment products.

At step 414, a financial trade of the pooled investment vehicle is automatically executed. In some embodiments, step 414 involves initially determining at least one recommended investment decision as described herein. A recommended investment decision can relate to a recommendation for buying or selling a particular investment product for the pooled investment vehicle. The investment product may relate to a particular business entity (e.g., a publically traded stock associated with a restaurant) and/or a generic category associated with the particular business entity (e.g., a mutual fund that invests in restaurants or entertainment) as described herein.

In some embodiments, step 414 involves executing the financial trade when a second critical mass threshold value is exceeded. In some embodiments, the second critical mass threshold value corresponds to a larger value than the critical mass threshold value of step 408. In some embodiments, step 414 involves automatically transmitting a request to a third-party system to execute a financial trade.

The embodiments described herein have been described with reference to drawings. The drawings illustrate certain details of specific embodiments that implement the systems, methods and programs described herein. However, describing the embodiments with drawings should not be construed as imposing on the disclosure any limitations that may be present in the drawings.

It should be understood that no claim element herein is to be construed under the provisions of 35 U.S.C. § 112(f), unless the element is expressly recited using the phrase “means for.”

As used herein, the term “circuit” may include hardware structured to execute the functions described herein. In some embodiments, each respective “circuit” may include machine-readable media for configuring the hardware to execute the functions described herein. The circuit may be embodied as one or more circuitry components including, but not limited to, processing circuitry, network interfaces, peripheral devices, input devices, output devices, sensors, etc. In some embodiments, a circuit may take the form of one or more analog circuits, electronic circuits (e.g., integrated circuits (IC), discrete circuits, system on a chip (SOCs) circuits), telecommunication circuits, hybrid circuits, and any other type of “circuit.” In this regard, the “circuit” may include any type of component for accomplishing or facilitating achievement of the operations described herein. For example, a circuit as described herein may include one or more transistors, logic gates (e.g., NAND, AND, NOR, OR, XOR, NOT, XNOR), resistors, multiplexers, registers, capacitors, inductors, diodes, wiring, and so on.

The “circuit” may also include one or more dedicated processors communicatively coupled to one or more dedicated memory or memory devices. In this regard, the one or more processors may execute instructions stored in the memory or may execute instructions otherwise accessible to the one or more processors. In some embodiments, the one or more processors may be embodied in various ways. The one or more processors may be constructed in a manner sufficient to perform at least the operations described herein. In some embodiments, the one or more processors may be shared by multiple circuits (e.g., circuit A and circuit B may comprise or otherwise share the same processor which, in some example embodiments, may execute instructions stored, or otherwise accessed, via different areas of memory). Additionally or alternatively, the one or more processors may be structured to perform or otherwise execute certain operations independent of one or more co-processors. In other example embodiments, two or more processors may be coupled via a bus to enable independent, parallel, pipelined, or multi-threaded instruction execution. Each processor may be implemented as one or more general-purpose processors, application specific integrated circuits (ASICs), field programmable gate arrays (FPGAs), digital signal processors (DSPs), or other suitable electronic data processing components structured to execute instructions provided by memory. The one or more processors may take the form of a single core processor, multi-core processor (e.g., a dual core processor, triple core processor, quad core processor), microprocessor, etc.

An example system for implementing the overall system or portions of the embodiments might include general purpose computing computers in the form of computers, including a processing unit, a system memory, and a system bus that couples various system components including the system memory to the processing unit. Each memory device may include non-transient volatile storage media, non-volatile storage media, non-transitory storage media (e.g., one or more volatile and/or non-volatile memories), etc. In some embodiments, the non-volatile media may take the form of ROM, flash memory (e.g., flash memory such as NAND, 3D NAND, NOR, 3D NOR), EEPROM, MRAM, magnetic storage, hard discs, optical discs, etc. In other embodiments, the volatile storage media may take the form of RAM, TRAM, ZRAM, etc. Combinations of the above are also included within the scope of machine-readable media. In this regard, machine-executable instructions comprise, for example, instructions and data which cause a general purpose computer, special purpose computer, or special purpose processing machines to perform a certain function or group of functions. Each respective memory device may be operable to maintain or otherwise store information relating to the operations performed by one or more associated circuits, including processor instructions and related data (e.g., database components, object code components, script components), in accordance with the example embodiments described herein.

It should also be noted that the term “input devices,” as described herein, may include any type of input device including, but not limited to, a keyboard, a keypad, a mouse, joystick or other input devices performing a similar function. Comparatively, the term “output device,” as described herein, may include any type of output device including, but not limited to, a computer monitor, printer, facsimile machine, or other output devices performing a similar function.

Any foregoing references to currency or funds are intended to include fiat currencies, non-fiat currencies (e.g., precious metals), and math-based currencies (often referred to as cryptocurrencies). Examples of math-based currencies include Bitcoin, Litecoin, Dogecoin, and the like.

It should be noted that although the diagrams herein may show a specific order and composition of method steps, it is understood that the order of these steps may differ from what is depicted. For example, two or more steps may be performed concurrently or with partial concurrence. Also, some method steps that are performed as discrete steps may be combined, steps being performed as a combined step may be separated into discrete steps, the sequence of certain processes may be reversed or otherwise varied, and the nature or number of discrete processes may be altered or varied. The order or sequence of any element or apparatus may be varied or substituted according to alternative embodiments. Accordingly, all such modifications are intended to be included within the scope of the present disclosure as defined in the appended claims. Such variations will depend on the machine-readable media and hardware systems chosen and on designer choice. It is understood that all such variations are within the scope of the disclosure. Likewise, software and web implementations of the present disclosure could be accomplished with standard programming techniques with rule based logic and other logic to accomplish the various database searching steps, correlation steps, comparison steps and decision steps

The foregoing description of embodiments has been presented for purposes of illustration and description. It is not intended to be exhaustive or to limit the disclosure to the precise form disclosed, and modifications and variations are possible in light of the above teachings or may be acquired from this disclosure. The embodiments were chosen and described in order to explain the principals of the disclosure and its practical application to enable one skilled in the art to utilize the various embodiments and with various modifications as are suited to the particular use contemplated. Other substitutions, modifications, changes and omissions may be made in the design, operating conditions and arrangement of the embodiments without departing from the scope of the present disclosure as expressed in the appended claims.

What is claimed is:

1. A provider computing system comprising:
a network interface structured to facilitate data communication via a network;
a database structured to store information associated with transactions and information associated with accounts held by an institution associated with the provider computing system; and
a processing circuit coupled to the network interface and the database, the processing circuit structured to:
collect user data relating to a group of users, each of the users associated with a user device;
transform the collected data to a data format corresponding to a statistical analysis model;
determine whether a critical mass threshold value is exceeded, the critical mass threshold value relating to an amount of collected user data;
in response to determining that the critical mass threshold value is exceeded, apply the statistical analysis model to the transformed data for determining a recommended investment decision for a pooled investment vehicle; and
generate a user interface for display by a user device, the user interface configured to provide information relating to the recommended investment decision.

2. The provider computing system of claim 1, wherein the collected user data comprises spending information relating to at least one user of the group.

3. The provider computing system of claim 2, wherein the spending information relates to transaction information passively collected by a user device associated with the user.

4. The provider computing system of claim 2, wherein the collected user data comprises location information passively collected by a user device associated with the user, the location information used to determine the spending information of the user.

5. The provider computing system of claim 2, wherein the spending information comprises information associated with transactions received from the database.

6. The provider computing system of claim 1, wherein the collected user data comprises information actively provided by at least one user device.

7. The provider computing system of claim 6, wherein the actively provided information comprises feedback information relating to a purchased good or service, the feedback information provided via the generated user interface.

8. The provider computing system of claim 1, further comprising:
receiving a trigger event from a user of the group, the trigger event relating to a request by the user to participate in the pooled investment vehicle.

9. The provider computing system of claim 1, further comprising:
automatically executing the recommended investment decision when a second critical mass threshold value is exceeded.

10. A method comprising:
collecting, by a provider computing system, user data relating to a group of users, each of the users associated with a user device, wherein the collected user data relates to a pooled investment vehicle having a number of investment products for generating income;
transforming, by the provider computing system, the collected data to a data format corresponding to a statistical analysis model;
determining, by the provider computing system, a critical mass threshold value is exceeded, the critical mass threshold value relating to an amount of collected user data;
in response to determining that the critical mass threshold value is exceeded, applying the statistical analysis model to the transformed data for determining a recommended investment decision for the pooled investment vehicle; and
generating, by the provider computing system, a user interface for display by at least one of the user devices, the user interface configured to provide information relating to the recommended investment decision.

11. The method of claim 10, wherein the collected user data comprises spending information relating to at least one user of the group.

12. The method of claim 11, wherein the spending information relates to transaction information passively collected by a user device associated with the user.

13. The method of claim 12, wherein the collected user data comprises location information passively collected by a user device associated with the user, the location information used to determine the spending information of the user.

14. The method of claim 12, wherein the spending information comprises information associated with transactions received from a database structured to store information associated with transactions and information associated with accounts held by an institution associated with the provider computing system.

15. The method of claim 11, wherein the collected user data comprises information actively provided by at least one user device.

16. The method of claim 15, wherein the actively provided information comprises feedback information relating to a purchased good or service, the feedback information provided via the generated user interface.

17. The method of claim 11, further comprising:
receiving a trigger event from a user of the group, the trigger event relating to a request by the user to participate in the pooled investment vehicle.

18. The method of claim 11, further comprising:
automatically executing the recommended investment decision when a second critical mass threshold value is exceeded.

19. A user device comprising:
a network interface structured to facilitate data communication via a network; and
a processing circuit having a processor and a memory, the processor structured to:
collect user data corresponding to a user of the user device, the collected user data relating to a pooled investment vehicle having a number of investment products for generating income;
determine whether a critical mass threshold value is exceeded, the critical mass threshold value relating to an amount of total user data, the total user data including the collected user data;
transform the total user data to a data format corresponding to a statistical analysis model;
in response to determining that the critical mass threshold value is exceeded, apply the statistical analysis model to the transformed data for determining a recommended investment decision for the pooled investment vehicle; and
generate a user interface for display by the user device, the user interface configured to provide information relating to the recommended investment decision.

20. The user device of claim 19, wherein the collected user data comprises spending information passively collected by the user device.

21. The user device of claim 20, wherein the collected user data comprises location information passively collected by the user device, the location information used to determine the spending information.

22. The user device of claim 19, wherein the collected user data comprises actively provided information.

23. The user device of claim 22, wherein the actively provided information comprises feedback information relating to a purchased good or service, the feedback information provided via the generated user interface.

24. The user device of claim 19, wherein the processing circuit is further configured to:
generate a second user interface for display by the user device, the user interface configured to receive a user request to participate in the pooled investment vehicle.

25. The user device of claim 19, wherein the processing circuit is further configured to:
automatically execute the recommended investment decision when a second critical mass threshold value is exceeded.
